(19) United States
(12) Patent Application Publication
(10) Pub. No.: US 2011/0197848 A1
(43) Pub. Date: Aug. 18, 2011

(54) PISTON MACHINE

(76) Inventor: Evgeny Nikolaevich Zakharov, Moscovskaya oblast (RU)

(21) Appl. No.: 12/998,371

(22) PCT Filed: Oct. 13, 2009
(86) PCT No.: PCT/RU2009/000541

§ 371 Date: Apr. 13, 2011

(30) Foreign Application Priority Data
Oct. 14, 2008 (RU) 2008140437

(51) Int. Cl. F02B 75/32; F01B 9/00

(52) U.S. Cl. 123/197.4; 92/140

(57) ABSTRACT

The invention relates to mechanical engineering, in particular to piston machines. The technical result of the invention consists in increasing the reliability and service life of the cylinder-piston group of a piston machine and the power-to-displacement ratio thereof (when the machine is used as an engine) by decreasing the mass of the reciprocatingly moving elements of the machine, and in improving the efficiency by substituting boundary sliding friction in a badly oiled cylinder-piston pair by rolling friction so that the rolling elements are prevented from slipping. The essence of the invention is that the crosshead and the body of the machine are provided with guides with contact surfaces and that rollers are arranged between the contact surfaces in order to transmit reactive energy from the crosshead to the body. Furthermore, the crosshead guides are positioned on two opposite sides thereof and at least on one side of the crosshead two rollers are situated, wherein the guides are provided with toothed racks and the rollers are provided with synchronising gears engaged with the toothed racks of the body and the crosshead.

### FIELD OF THE INVENTION

The invention relates to the sphere of machine building, in particular to piston machines.

### BRIEF DESCRIPTION OF THE DRAWINGS

As is known there exists a piston machine consisting of a housing which accommodates a crankshaft and a cylinder incorporating a piston made in the form of interconnected crosshead, skirt and head, where the crosshead is coupled with a crank by means of a connecting rod (Ref. RF Patent No. 2103533, published on Jan. 27, 1998).

The disadvantages of the known bearing machine are short life of the cylinder due to direct contact between contact surfaces of the crosshead (rollers) and the cylinder surface and their possible slipping, short life of rollers due to their heating from the cylinder surface and absence of a possibility for the piston head with rings to self-align relative to the cylinder surface in case of inaccurate adjustment of the rollers and during deformations of the mechanism or cylinder in the course of the piston machine operation.

### SUMMARY OF THE INVENTION

The technical result of the claimed invention consists in the increased reliability and life of the cylinder-piston group of a piston machine, increased power-to-volume ratio (when it is used as engine) due to decreased weight of reciprocating elements of the machine, and increased efficiency due substitution of boundary sliding friction in a poorly lubricated cylinder-piston couple for rolling friction while preventing rolling elements from slipping.

According to the invention, the objective is achieved by the fact that in a piston machine, consisting of a housing which accommodates a crankshaft with at least one crank and at least one cylinder secured to the housing and incorporating a piston made in the form of interconnected, at a minimum, crosshead and head, where the crosshead is coupled with a crank by means of a connecting rod, the crosshead and housing have guides with contact surfaces between which rollers are mounted and make it possible to transfer to the housing the reactive force acting on the side of the crosshead, where the crosshead guides are arranged on its two opposite sides, at least one side mounting two rollers, while the guides are provided with toothed racks and the rollers are provided with synchronizing pinions engaged with toothed racks of the guides of both housing and crosshead.

The claimed objective is also achieved by the fact that the piston head may be connected to the crosshead hingedly, thus enabling it to travel relative to the crosshead at least in the plane being perpendicular to the cylinder longitudinal axis, in any direction.

The claimed objective is also achieved by the fact that it may contain a guide tightening mechanism to create a pre-interference in the place where the contact surfaces are engaged with the rollers.

The claimed objective is also achieved by the fact that it may contain a mechanism providing spatial adjustment of the guides mounted at least on the housing.

The claimed objective is also achieved by the fact that the crosshead may be made as a box-like stiffener arranged in the plane of the reactive force action.

The claimed objective is also achieved by the fact that the crosshead stiffener may be located so as to pass between the crank cheeks during the piston motion towards the bottom dead center (BDC).

The claimed objective is also achieved by the fact that when the machine is used as a two-stroke engine, the housing guides may be installed inside the scavenge channels connecting the chamber under the piston with the cylinder chamber.

### BRIEF DESCRIPTION OF THE DRAWINGS

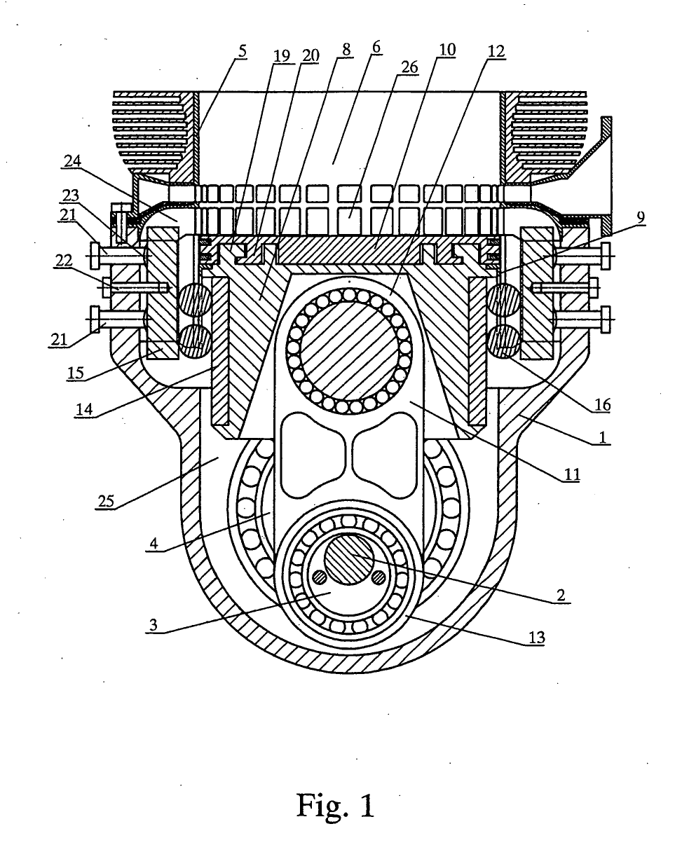

FIG. 1 shows the longitudinal section of the piston machine made as a two-stroke internal combustion engine, with the piston in BDC;

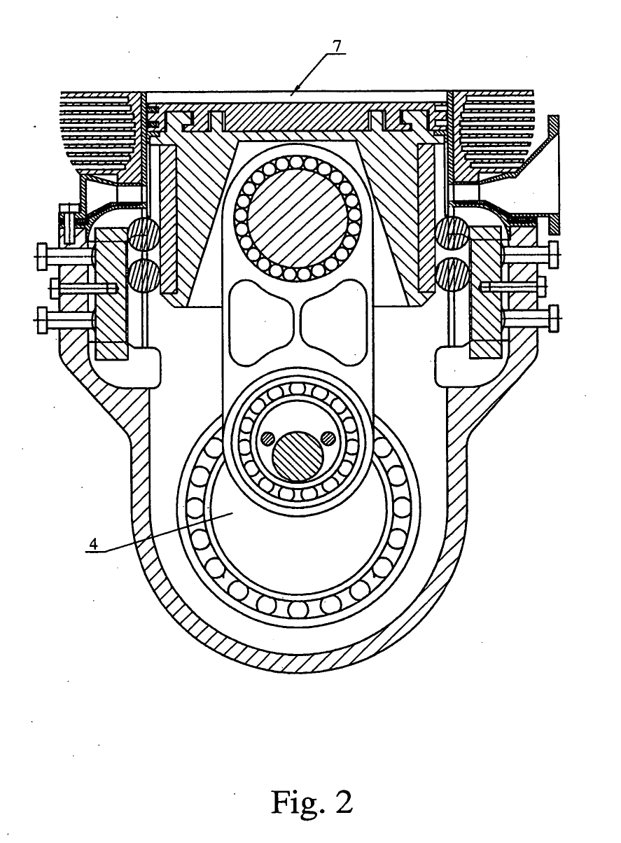

FIG. 2 shows the same, with the piston in TDC;

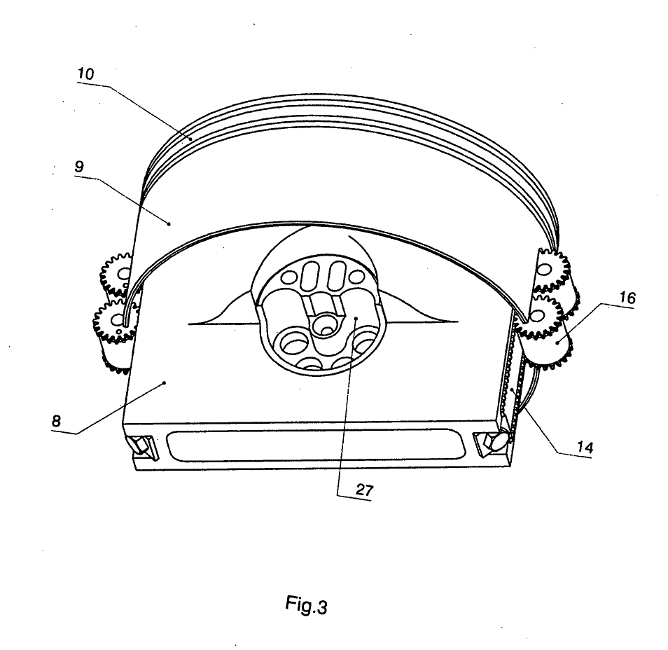

FIG. 3 shows the piston group assembly;

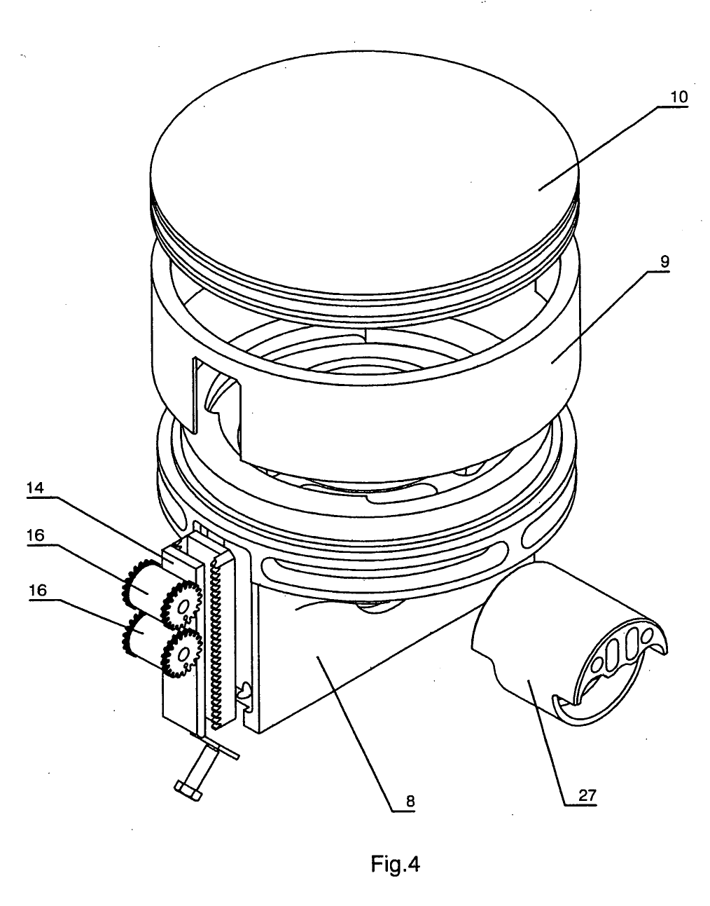

FIG. 4 shows the same, with designation of components.

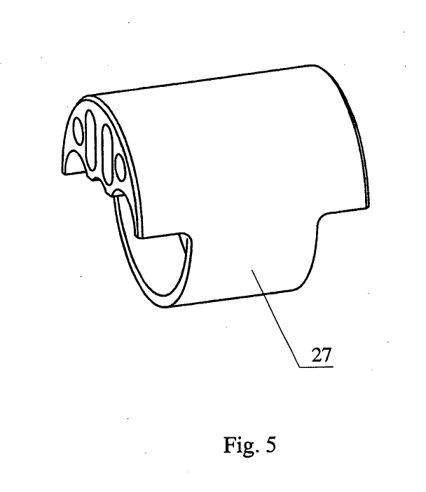

FIG. 5 shows the piston pin.

### THE BEST EMBODIMENT OF THE INVENTION

The described machine comprises housing 1 which accommodates crankshaft 2 with crank 3 and cheeks 4. The housing mounts cylinder 5 in chamber 6 of which piston 7 is located. Piston 7 is made in the form of interconnected crosshead 8, skirt 9 (if needed) and head 10. Crosshead 8 is coupled with crank 3 by means of connecting rod 11, having small end 12 and big end 13. Crosshead 8 is equipped with guides 14 with contact surfaces arranged on its two opposite sides, and the housing is provided with guides 15 with contact surfaces. Rollers 16 are mounted between the contact surfaces of guides 14 and 15 to transfer the lateral force of the reactive torque from crosshead 8 to housing 1. Each roller 16 is provided with pinions engaged with toothed racks 18 of guides 14 and 15, thus forming a synchronizing rack-and-pinion linkage. Head 10 of piston 7 may be connected with crosshead 8 hingedly, for example, with use of bayonet coupling made as circular projection 19 with a cut-out located on crosshead 8 and mating circular projection 20 on head 10 interfacing with the former. Such hinge, if made with a clearance in the radial direction, enables head 10 to travel relative to crosshead 8 in any radial direction, i.e. in the plane being perpendicular to cylinder 5 longitudinal axis.

Housing guides 15 may be equipped with a mechanism providing adjustment of their spatial position. The adjustment mechanism comprises threaded elements (bolts) 21 which contact by the ends with the non-operating surface of guide 15 and thrust, relative to housing 1, their contact surfaces against rollers 16 and against contact surfaces of guides 14 of crosshead 8. To prevent guides 15 from falling into the chamber of cylinder 5 during the machine assembly and to create a reliable contact with support end surfaces of bolts 21, guides 15 are drawn towards housing 1 to bolts by means of threaded connection 22 in the course of the machine operation. To relieve stresses in the threaded coupling and in the place where bolts 21 contact guides 15, thrust blocks 23 with spherical surfaces are mounted between the ends of bolts 21 and the guides.

Crosshead 8 may be made as a box-like stiffener arranged in the plane of the reactive force action. Therewith, small end 12 and the body of connecting rod 11 are arranged in the chamber of crosshead 8 box, and crosshead 8 box proper is located so as to pass between crank cheeks 4 during piston 7 motion towards the lower dead center.

If the machine is used as a two-stroke engine provided with by-pass channels communicating under-piston crankcase chamber 25 with chamber 6 of the cylinder, then housing guides 15 may be installed inside by-pass channels 24, through which, via scavenging ports 26, chamber 6 is scavenged and filled with a fresh charge.

The described piston machine operates as follows. Reciprocations of piston 7 are converted by means of connecting rod 11 and crank 3 into rotation of crankshaft 2 or, vice versa, rotation of shaft 2 is converted into reciprocation of piston 7. In any mechanism where conversion of motion takes place, a reactive force arises, which is taken up by the housing. In the piston machine the reactive force is usually taken up by the operating surface of the cylinder or, if a crosshead is available, by the guiding surface of the crosshead. The machine version with a crosshead is most preferable as in this case the cylinder is relieved from the function of translating the mechanism force action and, if the machine is used as an internal combustion engine, the heat is not transferred from heated (and therefore incapable of retaining lubricant) cylinder surfaces to the guiding surfaces, which take up the reactive force. However, the disadvantage of crosshead machines is theirs substantially increased dimensions and, consequently, increased reciprocating masses, which result in losses in the power-to-volume ratio due to the need in decreasing the rotational frequency of the internal combustion engine shaft.

The described invention makes it possible to make a crosshead machine (with all of its advantages) match the dimensions of a compact trunk machine. The objective is achieved due to installation of housing guides 15 of crosshead 8, which are not coupled with cylinder 5, within the height of cylinder 5 along its longitudinal axis. The reactive force is translated from crosshead 8 to housing 1 by means of rollers 16 mounted between guides 14 and 15 of crosshead 8 and housing 1, respectively. This technical solution makes it possible to substantially decrease the length of guides 14 and 15 as the working travel of roller 16 is always two times less than that of piston 7. This provides for fitting the crosshead assembly to the dimensions (in height) of cylinder 5 without increasing the engine radial dimensions (along the cylinder axis). Besides, friction losses in the cylinder-piston group become the next order lower than those in trunk machines. Accordingly, heating of interfacing surfaces within this couple is decreased as well. It means that in the describes engine cylinder 5 is relieved from the effect of local mechanical and thermal overloads, which in the known machines irregularly deform the cylinder inner surface along its circumference, thus substantially deteriorating its functions as regards the work space sealing.

The synchronizing rack-and-pinion linkage consisting of racks 18 and pinions 17 prevents rollers 16 from slipping relative to the contact surfaces of guides 14 and 15. As is known, it is precisely the phenomenon of rolling elements slipping in bearings that limits their load, speed and life parameters.

Presence of the crosshead assembly requires an adjustment assembly to be included in the machine structure. The known engines ensure the capability of both changing spatial position of the crosshead guide and changing the crosshead position relative to the guide, for example, with use of a set of shims. In the described machine, in addition to the adjustment mechanism, which provides for thrusting guides 15 of housing 1 through rollers 16 to guides 14 of crosshead 8 with use of, for example, bolts 21, provision is made for additional self-alignment of sealing part 10 (of the head) of piston 7 relative to the inner surface of cylinder 5. The radial clearance in the bayonet coupling of head 10 with crosshead 8 enables head 10 with sealing rings 26 mounted therein to occupy an optimal position inside cylinder 5 irrespective of the position of crosshead 8, which depends on the performed adjustment of the position of guides 15. Mostly, this is necessary when using the machine as an internal combustion engine to compensate for mechanical and thermal losses occurring in the course of operation of, for example, a high-powered engine. Besides, this provides a uniform clearance between the head and cylinder, in particular, in a two-stroke engine, which improves the head surface heating regularity, especially for the case of slot-type gas distribution.

Employment of narrow guides 14 and 15 as supports makes it possible to shape the load-bearing part of crosshead 8 as a box-like stiffener with guides 14 secured to its opposite sides. The box of crosshead 8 accommodates small end 12 and some part of connecting rod 11. Small end 12 is mounted on piston pin 27 through roller bearing 28, while pin 27 is inserted into a hole in crosshead 8. Such configuration of the assembly enables the box-like stiffener of crosshead 8 to pass between cheeks 4 of shaft 2, when piston 7 approaches to BDC, which makes it possible to additionally decrease the machine dimensions along cylinder 5 axis.

When the described machine is used as a two-stroke engine, practically no force breaking piston 7 away from connecting rod 11 occurs (as against a four-stroke engine). Therefore, the width of the box walls of crosshead 8, which retain piston pin 27 and take up break-away loads acting along the cylinder axis, may be minimum. As the force translated from crosshead 8 to pin 27 at the instance of combustion is relatively high, pin 27 should be provided with a larger surface on the side of the gas load action. I.e. pin 27 may have a stepped structure, with segment cut-outs on the side of its ends, which makes it possible to draw piston 7 to shaft 2 even closer due to the possibility to make some part of pin 27 together with the box-like stiffener of crosshead 8 pass between cheeks 4. Such solution also results in decreased dimensions of the machine along cylinder 5 axis.

Installation of guides 15 inside scavenge channels 24 of a two-stroke engine with crankcase scavenging makes it possible to use a cavity (channel 24) already available in the engine without blocking it by rollers 16 during scavenging, as with piston 7 in BDC (during scavenging) rollers 16 occupy their extreme lower position. In the two-stroke version of the machine, skirt 9 of piston 7 may be used as a shut-off element for outlet ports 29 with piston 7 in TDC, which will prevent the fresh charge from directly contacting with combustion products in crankcase chamber 25. Therewith, as against the known piston machines, in the declared machine skirt 9 does not take up any considerable loads and therefore may be made thin-walled, i.e. light-weight.

### INDUSTRIAL APPLICABILITY

Thus, the declared piston machine demonstrates the maximum set of the best qualities, in particular when it is used exactly as a two-stroke internal combustion engine. Employment of the said engine makes it possible to relieve the cylinder from action of the reactive force and to decrease it heating, thereby increasing the tightness of the work space and operational reliability of the cylinder-piston group as a whole. Compact size of the assembly translating the action of the reactive force to the housing makes it possible to substantially decrease the engine radial dimensions even as compared to compact trunk engines, which results in a reduced weight of reciprocating parts, thus extending the range of the shaft permissible rotational frequency limited by tolerable load on the bearing of the connecting rod big end due to its exposure to the inertial force in BDC. I.e. both increased load-bearing capacity of the cylinder-piston group and increased permissible rotational frequency of the shaft make it possible to substantially increase the power-to-volume ratio, in particular, in a two-stroke engine, while thereby solved problems of efficiency make it possible to operate the engine with record-breaking high power-to-volume ratios at an acceptable service life.

1. A piston machine, comprising a housing which accommodates a crankshaft with at least one crank and at least one cylinder secured to the housing and incorporating a piston made in the form of interconnected, at a minimum, crosshead and head, where the crosshead is coupled with a crank by means of a connecting rod, characterized in that the crosshead and housing have guides with contact surfaces between which rollers are mounted and make it possible to transfer to the housing the reactive force acting on the side of the crosshead, where the crosshead guides are arranged on its two opposite sides, at least one side mounting two rollers, while the guides are provided with toothed racks and the rollers are provided with synchronizing pinions engaged with toothed racks of the guides of both housing and crosshead.

2. A machine of claim 1, wherein the piston head is connected to the crosshead hingedly, thus enabling it to travel relative to the crosshead at least in the plane being perpendicular to the cylinder longitudinal axis, in any direction.

3. A machine of claim 1, wherein it comprises a guide tightening mechanism to create a pre-interference in the place where the contact surfaces are engaged with the rollers.

4. A machine of claim 1, wherein it comprises a mechanism providing spatial adjustment of the guides mounted at least on the housing.

5. A machine of claim 1, wherein the crosshead is made as a box-like stiffener arranged in the plane of the reactive force action.

6. A machine of claim 5, wherein the crosshead stiffener is located so as to pass between the crank cheeks during the piston motion towards the bottom dead center.

7. A machine of claim 1, wherein being used as a two-stroke engine, the housing guides are installed inside the scavenge channels connecting the chamber under the piston with the cylinder chamber.
